(19) United States
(12) Patent Application Publication
(10) Pub. No.: US 2003/0194064 A1
(43) Pub. Date: Oct. 16, 2003

(54) System and method for delivering web products to a subscriber unit

(76) Inventors: Anne Yin-Fee Lee, Naperville, IL (US); Ronald Bruce Martin, Carol Stream, IL (US)

Correspondence Address: PATTI & BRILL, ONE NORTH LASALLE STREET, 44TH FLOOR, CHICAGO, IL, 60602, US

(21) Appl. No.: 10/120,047

(22) Filed: Apr. 10, 2002

(51) Int. Cl. H04M 1/64

(52) U.S. Cl. 379/88.17

(57) ABSTRACT

A system for delivering web products to a subscriber unit including: (a) at least one subscriber unit equipped for processing web signals; (b) a telecommunication network coupled with the at least one subscriber unit; and (c) at least one web provider station coupled with the telecommunication network. Each respective web provider station is responsive to a predetermined call code for providing a predetermined web product to a particular subscriber unit via the telecommunication network.

### BACKGROUND OF THE INVENTION

The present invention is directed to a system and method for delivering web products to a subscriber unit. The preferred embodiment of the present invention contemplates delivery of web site contents to a subscriber unit in a telecommunication network. The subscriber unit may be any communication unit configured for handling web information, such as a personal digital assistant (PDA), a wireless telephone or a desktop personal computer (PC) or telephone instrument.

By way of example, the present invention provides a system and method for providing access by a wireless Internet protocol (IP) capable device to a website via a phone call or similar dynamic session. As website connections are presently configured and billed, the Quality of Service (QoS) level for a given connection session is set at the outset or beginning of the session and remains unchanged throughout the session. Moreover, the QoS level is established or set by the website host. There is no capability provided for callers to select or set their own QoS level. Different web products require different QoS levels for optimum presentation. However, if a caller, for example a caller using a wireless device for access to a website, wishes to merely be able to access information from a website without particularly caring about the quality of the presentation, the caller may find it advantageous to access the website using a lesser or lower QoS level. Such a lower QoS level may be billed at a lower rate. On the other hand, a website host may desire that only a particular QoS level be allowed in obtaining a particular web product. In such a situation it would be advantageous if the website host could provide a caller a choice whether to receive the web product at the required QoS level or opt out of receiving the web product.

Presently, there is no direct availability for web products by wireless devices without browsing or otherwise navigating a website or similar service provider. It would be advantageous for advertisers and other offerors of web products to be able to provide easy and direct access to their messages by wireless subscribers to a telecommunication network.

### SUMMARY OF THE INVENTION

A system for delivering web products to a subscriber unit including: (a) at least one subscriber unit equipped for processing web signals; (b) a telecommunication network coupled with the at least one subscriber unit; and (c) at least one web provider station coupled with the telecommunication network. Each respective web provider station is responsive to a predetermined call code for providing a predetermined web product to a particular subscriber unit via the telecommunication network.

It is therefore an object of the present invention to provide a system and method for delivering web products to a subscriber unit that avails a user selected web products by wireless devices without browsing or otherwise navigating a website or similar service provider.

It is a further object of the present invention to provide a system and method for delivering web products to a subscriber unit that makes it advantageous for advertisers and other offerors of web products to provide easy and direct access to their messages and other materials by wireless subscribers to a telecommunication network.

It is yet a further object of the present invention to provide a system and method for delivering web products to a subscriber unit that permits varying the Quality of Service (QoS) level of the presentation during a connection session with a website.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating a prior art system for delivering web products to a subscriber unit.

FIG. 2 is a schematic diagram illustrating a system for delivering web products to a subscriber unit configured according to one embodiment of the system of the present invention.

FIG. 3 is a schematic diagram illustrating a system for delivering web products to a subscriber unit configured according to a second embodiment of the system of the present invention.

FIG. 4 is a flow chart illustrating the method of the present invention.

### DETAILED DESCRIPTION OF THE PREFERRED EMBODIMENT

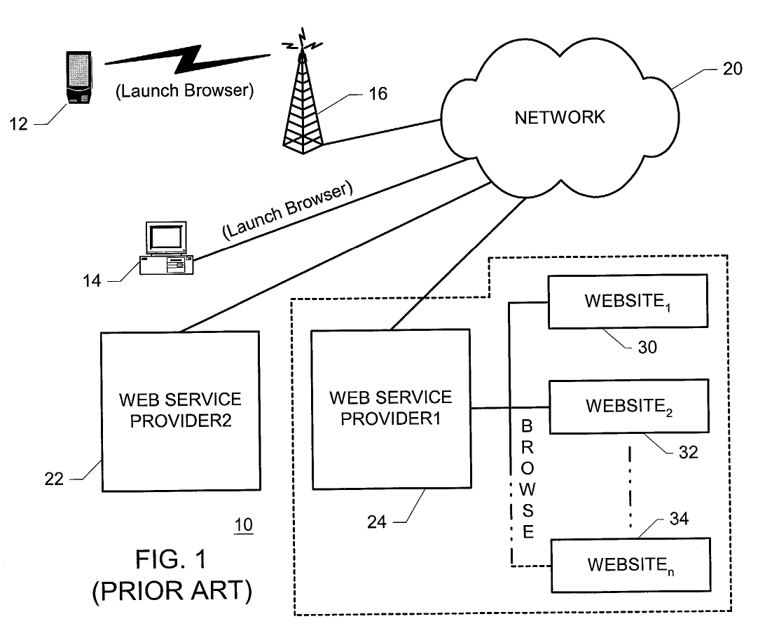

FIG. 1 is a schematic diagram illustrating a prior art system for delivering web products to a subscriber unit. In FIG. 1, a system 10 for delivering web products includes subscriber or calling units 12, 14. Subscriber unit 12 represents a wireless communication device such as a wireless-capable personal digital assistant (PDA) device or a wireless telephone device. Subscriber unit 12 is communicatingly coupled with a wireless communication access facility 16, such as a cellular telephone tower in a mobile telephone system (not shown in detail in FIG. 1). Wireless communication access facility 16 is coupled with a telecommunication network 20. Subscriber unit 14 represents a personal computer (PC) device. Subscriber unit 14 is communicatingly coupled with telecommunication network 20.

Telecommunication network 20 may include any of one or more of several networks such as a public switched telephone network (PSTN) and includes virtual private networks, private networks and other limited access network configurations coupled or otherwise arranged to provide communications among a variety of devices. Exemplary devices serviced by telecommunication network 20 may include, by way of example and not by way of limitation, wired telephones, wireless telephones, personal computers (PCs), personal digital assistant (PDA) devices, mobile land radio units, and other communication devices. Coupling with telecommunication network 20 may be effected by several communication technologies and milieux including, by way of example and not by way of limitation, any mode of electronic transmission of information such as voice, data and video communications, whether delivered via systems employing digital, analog, ISDN, optical, wireline, wireless, or other delivery technologies. Also included within the contemplated technological applicability of the present invention are voice, data or video signals delivered over the Internet, via satellite communications, or via other delivery media.

Telecommunication network 20 is coupled with exemplary web service providers 22, 24. Details are provided in FIG. 1 relating to web service provider 24; similar details exist relating to web service provider 22 but are not presented in FIG. 1 in order to avoid cluttering FIG. 1. Web service provider 24 is associated with a plurality of websites 30, 32, 34. The subscript “n” is employed in FIG. 1 in connection with websites 30, 32, 34 to indicate that there is no limit to the number of websites that may be associated with web service provider 24. Association between websites 30, 32, 34 and web service provider is via a browse relationship. That is, in order for a subscriber unit 12, 14 to access a particular website 30, 32, 34, subscriber unit 12, 14 must launch a browser (i.e., a program designed for navigating a website) via telecommunication network 20 and web service provider 24 to browsingly interact (i.e., to navigate within a website using browser software) with one or more website 30, 32, 34 associated with web service provider 24.

Requiring a subscriber unit 12, 14 to have a browser capability increases the memory requirement for a subscriber unit 12, 14. Such required increased memory contributes to increased complexity of construction and operation of a subscriber unit 12, 14. Increased complexity contributes to increased cost for a subscriber unit 12, 14. The complexity of the connection established between a respective subscriber unit 12, 14 and a website 30, 32, 34 is also rendered complex by involving browsers. Complex connections are susceptible to interruption, a situation that is exacerbated when the connection involves a wireless segment, as between subscriber unit 12 and wireless communication access facility 16 in system 10 (FIG. 1).

It would be advantageous to be able to access a website via a phone call rather than employing browser technology for effecting access. Such a phone call access capability would be especially advantageous when seeking to access a website using a wirelessly connected subscriber unit, such as a PDA or a wireless telephone device. A focused approach to addressing a website may be described by way of example (and not by way of limitation) as accessing a horoscope. A caller could dial a phone number, such as “1-800-HOROSCOPE” to connect with a horoscope website for the particular astrological sign of the caller. Browsing a website to find horoscope information and further browsing to locate horoscope information relating to a particular astrological sign is avoided by effecting direct access using a particular phone number. Alternatively, such a focused website arrangement contemplates, for example, that the website present a menu of options to a subscriber that has successfully dialed up access. Options may be selected by entering a number or numbers from the phone keypad to initiate a second call leg for the same call session. In such manner, a single site may be accessed for horoscope information and a second call leg may be initiated once a particular astrological sign is selected using the menu presented by the website.

Another approach to accessing websites by telephone is to provide connection using a phone number to connect with an Internet Service Provider (ISP) such as AOL (America On-Line) to establish general/portal access with a website. Such an approach would require a caller to dial, for example, “1-800-AOL” to effect connection with an Internet portal provided by AOL. Yet another example involves Internet Protocol (IP) telephony using an SIP (Session Initiation Protocol) call control protocol for calls using URL (Universal Resource Locator) addresses to access websites directly. Proper construction of websites is necessary to fully utilize these latter examples—general/portal access or SIP call control protocol—to facilitate phone navigating within a website rather than browser navigating once coupling with the website is achieved, such as by using number entries by callers to initiate second call legs to access particular information.

Thus, a subscriber unit that is equipped for processing web signals, such as being HTML (Hyper Text Markup Language) capable, can directly access a given website and receive intelligible information from that website without having to launch a browser or having to effect a browsing navigation of the website.

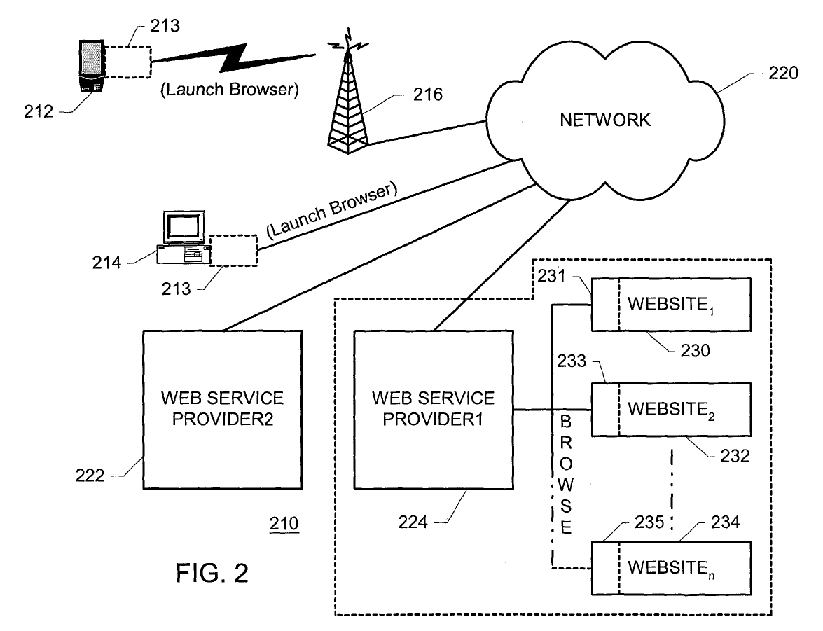

FIG. 2 is a schematic diagram illustrating a system for delivering web products to a subscriber unit configured according to one embodiment of the system of the present invention. In FIG. 2, a system 210 for delivering web products is similar in construction to system 10 (FIG. 1). System 210 includes subscriber or calling units 212, 214. Subscriber unit 212 represents a wireless communication device such as a wireless-capable personal digital assistant (PDA) device or a wireless telephone device. Subscriber unit 212 is communicatingly coupled with a wireless communication access facility 216, such as a cellular telephone tower in a mobile telephone system (not shown in detail in FIG. 2). Wireless communication access facility 216 is coupled with a telecommunication network 220. Subscriber unit 214 represents a personal computer (PC) device. Subscriber unit 214 is communicatingly coupled with telecommunication network 220.

Telecommunication network 220 may include any of one or more of several networks such as a public switched telephone network (PSTN) and includes virtual private networks, private networks and other limited access network configurations coupled or otherwise arranged to provide communications among a variety of devices. Exemplary devices serviced by telecommunication network 220 may include, by way of example and not by way of limitation, wired telephones, wireless telephones, personal computers (PCs), personal digital assistant (PDA) devices, mobile land radio units, and other communication devices. Coupling with telecommunication network 220 may be effected by several communication technologies and milieux including, by way of example and not by way of limitation, any mode of electronic transmission of information such as voice, data and video communications, whether delivered via systems employing digital, analog, ISDN, optical, wireline, wireless, or other delivery technologies. Also included within the contemplated technological applicability of the present invention are voice, data or video signals delivered over the Internet, via satellite communications, or via other delivery media.

Telecommunication network 220 is coupled with exemplary web service providers 222, 224. Details are provided in FIG. 2 relating to web service provider 224; similar details exist relating to web service provider 222 but are not presented in FIG. 2 in order to avoid cluttering FIG. 2. Web service provider 224 is associated with a plurality of websites 230, 232, 234. The subscript “n” is employed in FIG. 2 in connection with websites 230, 232, 234 to indicate that there is no limit to the number of websites that may be associated with web service provider 224. Association between websites 230, 232, 234 and web service provider is via a browse relationship. That is, in order for a subscriber unit 212, 214 to access a particular website 230, 232, 234, subscriber unit 212, 214 must launch a browser (i.e., a program designed for navigating a website) via telecommunication network 220 and web service provider 224 to browsingly interact (i.e., to navigate within a website using browser software) with one or more website 230, 232, 234 associated with web service provider 224.

Each respective website 230, 232, 234 may include a respective Quality of Service (QoS) level selection unit 231, 233, 235. Each subscriber unit 212, 214 also may include a respective Quality of Service (QoS) level selection unit 213, 215. QoS level selection units 231, 233, 235, 213, 215 may be embodied in software, in hardware or in a combination of software and hardware. The capability provided by QoS level selection units 231, 233, 235, 213, 215 permits variance of QoS level in the connection between a subscriber unit 212, 214 and a respective website 230, 232, 234 during a connection session between a subscriber unit 212, 214 and a website 230, 232, 234. The adjustment or variance of QoS level may be effected, for example, by a user at a respective subscriber unit 212, 214, as by “clicking” on an icon or effecting another entry to indicate a desired adjustment in QoS level. QoS level adjustment may be made stepwise in response to “clicking” on an icon or using another adjustment level alteration method.

Alternatively, a respective website 230, 232, 234 may indicate to a user at a respective subscriber unit 212, 214 that a particular QoS level must be employed for receiving a particular web product. An opportunity may be provided by the respective website 230, 232, 234 to a respective subscriber unit 212, 214 to agree to accept the required QoS level or to opt out of receiving the particular web product. Indication of acceptance of the particular QoS level or opting out of receiving the particular web product may be indicated, for example, by “clicking” on an icon or by another entry at the respective subscriber unit 212, 214.

QoS selection units 231, 233, 235, 213, 215 are indicated in FIG. 2 in dotted line format to illustrate that QoS level selection may be effected to one degree or another at either locus—at subscriber units or at websites—or at both loci. That is, either of subscriber units 212, 214 (through QoS level selection units 213, 215) or websites 230, 232, 234 (through QoS level selection units 231, 233, 235) can impose or propose a QoS level upon a communication link extant between a subscriber unit and a website. Alternatively, only one of the communicants—a subscriber unit 212, 214 or a website 230, 232, 234 may impose a QoS level on the link.

The present invention also contemplates and includes provision for negotiation between communicants—subscriber units and websites—regarding a QoS level to be imposed upon an extant communication link. For example, website 230 may propose a first QoS level to subscriber unit 212 regarding an extant communication link between website 230 and subscriber unit 212. Subscriber unit 212 may indicate acceptance of the proposed QoS level or may propose another desired QoS level. The other proposed QoS level may be accepted by website 230 or may be rejected by website 230, or website 230 may propose yet another QoS level. Such negotiations may occur because a web product provider may desire that certain web products only be presented using a particular QoS level or better in order that proper presentation of the product may occur.

Websites 230, 232, 234 preferably include a capability—embodied in software, or hardware or in a combination of software and hardware—for effecting service billing at various rates for connection sessions between subscriber units 212, 214 and websites 230, 232, 234 at various QoS levels, regardless of which locus—subscriber unit or website—is equipped with a QoS level selection unit.

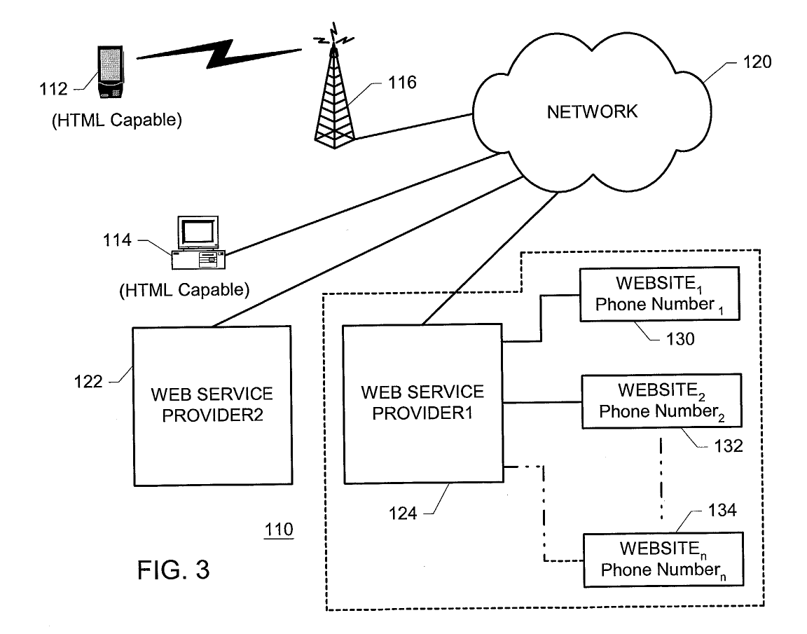

FIG. 3 is a schematic diagram illustrating a system for delivering web products to a subscriber unit configured according to a second embodiment of the system of the present invention. In FIG. 3, a system 110 for delivering web products includes subscriber or calling units 112, 114. Subscriber unit 112 represents a wireless communication device such as a wireless-capable personal digital assistant (PDA) device or a wireless telephone device. Subscriber unit 112 is communicatingly coupled with a wireless communication access facility 116, such as a cellular telephone tower in a mobile telephone system (not shown in detail in FIG. 3). Wireless communication access facility 116 is coupled with a telecommunication network 120. Subscriber unit 114 represents a personal computer (PC) device. Subscriber unit 114 is communicatingly coupled with telecommunication network 120. Subscriber units 112, 114 are equipped for processing web signals, such as being HTML (Hyper Text Markup Language) capable.

Telecommunication network 120 may include any of one or more of several networks such as a public switched telephone network (PSTN) and includes virtual private networks, private networks and other limited access network configurations coupled or otherwise arranged to provide communications among a variety of devices. Exemplary devices serviced by telecommunication network 120 may include, by way of example and not by way of limitation, wired telephones, wireless telephones, personal computers (PCs), personal digital assistant (PDA) devices, mobile land radio units, and other communication devices. Coupling with telecommunication network 120 may be effected by several communication technologies and milieux including, by way of example and not by way of limitation, any mode of electronic transmission of information such as voice, data and video communications, whether delivered via systems employing digital, analog, ISDN, optical, wireline, wireless, or other delivery technologies. Also included within the contemplated technological applicability of the present invention are voice, data or video signals delivered over the Internet, via satellite communications, or via other delivery media.

Telecommunication network 120 is coupled with exemplary web service providers 122, 124. Details are provided in FIG. 3 relating to web service provider 124; similar details exist relating to web service provider 122 but are not presented in FIG. 3 in order to avoid cluttering FIG. 3. Web service provider 122 may be, for example, a Internet Service Provider (ISP) like America On-Line (AOL) suitable for configuration to employ the present invention advantageously in a general/portal access application, as discussed above.

Web service provider 124 is associated with a plurality of websites 130, 132, 134. The subscript “n” is employed in FIG. 2 in connection with websites 130, 132, 134 to indicate that there is no limit to the number of websites that may be associated with web service provider 124. Association between websites 130, 132, 134 and web service provider is via a respective phone number assigned to or otherwise associated with each respective website 130, 132, 134. Thus Website 130 is assigned Phone Number₁. Website 132 is assigned Phone Number₂. Website 134 is assigned Phone Numberₙ. That is, in order for a subscriber unit 112, 114 to access a particular website 130, 132, 134, subscriber unit 112, 114 simply dials (or otherwise enters) a respective phone number—Phone Number₁, Phone Number₂, Phone Numberₙ—to effect connection with a website 130, 132, 134 via telecommunication network 120 and web service provider 124.

Providing direct access to websites 130, 132, 134 using direct dial-up connections, and providing HTML capability for subscriber units 112, 114 simplifies and reduces the memory requirement for subscriber units 112, 114 in system 110 (FIG. 3) as compared with the memory requirements associated with implementing similar website access in system 10 (FIG. 1). Such comparatively reduced memory reduces complexity of construction and operation of subscriber units 112, 114 (system 110; FIG. 3) as compared to subscriber units 12, 14 (system 10; FIG. 1). Reduced complexity contributes to reduced cost. The complexity of the connection established between a respective subscriber unit 112, 114 and a website 130, 132, 134 is also rendered less complex by avoiding use of browsers. Connections that are less complex are less susceptible to interruption, a situation that is particularly advantageous when the connection involves a wireless segment, as between subscriber unit 112 and wireless communication access facility 116 in system 110 (FIG. 3).

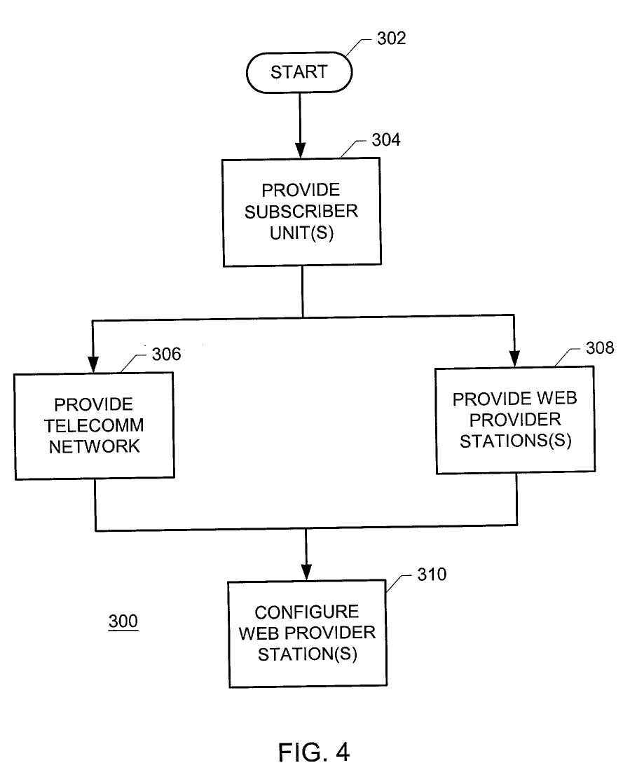

FIG. 4 is a flow chart illustrating the method of the present invention. In FIG. 4, a method 300 for delivering web products to a subscriber unit begins at a START locus 302. Method 300 continues, providing at least one subscriber unit, as indicated by a block 304. Method 300 further continues by, in no particular order: (a) providing a telecommunication network, as indicated by a block 306; and (b) providing at least one web provider station, as indicated by a block 308.

Each of the at least one subscriber station provided according to block 304 is equipped for processing web signals. The telecommunication network provided according to block 306 is coupled with the at least one subscriber unit provided according to block 304. The at least one web provider station provided according to block 308 is coupled with the telecommunication network provided according to block 306.

Method 300 continues by configuring each respective web provider station to be responsive to a predetermined call code, as indicated by a block 310. Each predetermined call code effects providing a predetermined web product to a particular subscriber unit via the telecommunication network.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

We claim:

1. A system for delivering web products to a subscriber unit; the system comprising:
(a) at least one subscriber unit; said at least one subscriber unit being equipped for processing web signals;
(b) a telecommunication network coupled with said at least one subscriber unit; and
(c) at least one web provider station coupled with said telecommunication network; each respective web provider station of said at least one web provider station being responsive to a predetermined call code for providing a predetermined web product to a particular subscriber unit of said at least one subscriber unit via said telecommunication network.

2. A system for delivering web products to a subscriber unit as recited in claim 1 wherein said predetermined call code includes a unique phone number identifying said respective web provider.

3. A system for delivering web products to a subscriber unit as recited in claim 1 wherein said predetermined call code includes information identifying said particular subscriber unit as being equipped for processing web signals.

4. A system for delivering web products to a subscriber unit as recited in claim 2 wherein said predetermined call code includes information identifying said particular subscriber unit as being equipped for processing web signals.

5. A system for accessing web information via a telecommunication network; the system comprising:
(a) a plurality of communication units coupled with said telecommunication network; and
(b) a plurality of web providers coupled with said telecommunication network; said plurality of web providers being configured for selective communication access by said plurality of communication units to establish a web session between a particular web provider of said plurality of web providers and a particular communication unit of said plurality of communication units; at least one of said particular web provider and said particular communication device including a quality of service variance unit; said quality of service variance unit imposing a selected quality of service level for said communication access during said web session in response to a quality of service selection indication; said quality of service selection indication being provided by at least one of said particular communication unit and said particular web provider.

6. A system for accessing web information via a telecommunication net as recited in claim 5 wherein said plurality of communication units is equipped for processing web signals and wherein a respective communication unit of said plurality of communication units uses a predetermined respective call code for effecting communications with a respective web provider of said plurality of web providers; said respective web provider responding to said predetermined respective call code by providing predetermined respective web information to said respective communication unit via said telecommunication network.

7. A system for accessing web information via a telecommunication network as recited in claim 6 wherein said predetermined respective call code includes a unique phone number identifying said respective web provider.

8. A system for accessing web information via a telecommunication network as recited in claim 6 wherein said predetermined respective call code includes notice identifying said respective communication unit as being equipped for processing web information.

9. A system for accessing web information via a telecommunication network as recited in claim 7 wherein said predetermined respective call code includes notice identifying said respective communication unit as being equipped for processing web information.

10. A method for delivering web products to a subscriber unit; the method comprising the steps of:
(a) providing at least one subscriber unit; said at least one subscriber unit being equipped for processing web signals;
(b) in no particular order:
(1) providing a telecommunication network coupled with said at least one subscriber unit; and
(2) providing at least one web provider station coupled with said telecommunication network; and
(c) configuring each respective web provider station of said at least one web provider station to be responsive to a predetermined call code for providing a predetermined web product to a particular subscriber unit of said at least one subscriber unit via said telecommunication network.

11. A method for delivering web products to a subscriber unit as recited in claim 10 wherein said predetermined call code includes a unique phone number identifying said respective web provider.

12. A method for delivering web products to a subscriber unit as recited in claim 10 wherein said predetermined call code includes information identifying said particular subscriber unit as being equipped for processing web signals.

13. A method for delivering web products to a subscriber unit as recited in claim 11 wherein said predetermined call code includes information identifying said particular subscriber unit as being equipped for processing web signals.
